(19) United States
(12) Patent Application Publication
(10) Pub. No.: US 2024/0328645 A1
(43) Pub. Date: Oct. 3, 2024

(54) CEILING ELEMENT WITH AIR OUTLET BOX

(71) Applicant: ZEHNDER GROUP INTERNATIONAL AG, CH-5722 GRÄNICHEN (CH)

(72) Inventor: Max MEIER, Kippenheim (DE)

(73) Assignee: ZEHNDER GROUP INTERNATIONAL AG, CH-5722 GRÄNICHEN (CH)

(21) Appl. No.: 18/579,700

(22) PCT Filed: Sep. 6, 2022
(86) PCT No.: PCT/EP2022/074753

§ 371 Date: Jan. 16, 2024

(30) Foreign Application Priority Data
Sep. 15, 2021 (CH) 070270/2021

(51) Int. Cl. F24F 5/00

(52) U.S. Cl. CPC F24F 5/0092

(57) ABSTRACT

A ceiling element for cooling and/or heating a ceiling includes a ceiling panel with a ceiling panel upper side and a pipe system arranged on the ceiling panel upper side with pipes extending in the longitudinal direction of the ceiling panel for transporting a heat-carrying fluid. An air outlet box arranged on the ceiling panel upper side with a supply air inlet and a plurality of air outlets open to the surroundings, wherein the pipes of the pipe system extend through the air outlet box and wherein the air outlets are arranged such that air exiting from the air outlets runs on the ceiling panel upper side.

### BACKGROUND OF THE INVENTION

### Field of the Invention

The present invention lies in the technical field of ceiling temperature control, in particular floating ceilings, and relates to a ceiling element for a cooling and/or heating ceiling, as well as to a use of such a ceiling element.

### Discussion of Related Art

Ceiling elements for cooling and/or heating ceilings are known in the state of the art. These typically have a flat plate on which pipes containing a heat-carrying fluid are arranged. Such ceiling elements are often used as floating ceilings, i.e. they are mounted below the ceiling in such a way that a space is created between the ceiling and the ceiling element. The air in this space can then exchange heat energy with the heat-carrying fluid in the pipes. The fluid can be cooler than the room air, i.e. it has a relatively negative heat energy, such that heat is transferred from the room to the fluid in order to cool the room. Alternatively, the heat-carrying fluid can have a positive heat energy relative to the room, such that heat is transferred from the fluid to the air in the intermediate space and the room is heated accordingly.

Various air outlet systems or air diffuser systems are used to distribute the tempered air, i.e. the air that has exchanged heat with the fluid in the pipes, in the room. A first type of such a system is a displacement diffuser, i.e. an outlet system that blows the air downwards into the room through the ceiling element. The ceiling element has a ceiling panel with holes or perforations through which the air is blown vertically into the room. This is disadvantageous for a plurality of reasons. On the one hand, the ceiling element must be perforated, which is often aesthetically undesirable and also has a lower heating or cooling capacity than a smooth element. In addition, the vertically downward air ejection through the perforations leads to draughts, which are perceived as unpleasant by the people in the room. Furthermore, displacement diffusers require a certain minimum distance between the individual fluid-carrying pipes in order to ensure high efficiency, which in turn requires a minimum width of the ceiling element.

A second type of air outlet systems or air diffuser systems are so-called induction diffusers, which typically utilize the Coanda effect. In such systems, it is necessary to remove the activation, i.e. the fluid-carrying pipes, in the region where the air outlet is located, which reduces the active area and decreases the performance.

### SUMMARY OF THE INVENTION

It is therefore the general object of the invention to further develop the state of the art in the field of ceiling temperature control in rooms and preferably to overcome the disadvantages of the state of the art in whole or in part. In advantageous embodiments, a ceiling element is provided by which draughts are reduced, in particular avoided. In further advantageous embodiments, a ceiling element is provided which, compared to the prior art, has a higher performance with the same surface area of the element and is thus more efficient.

The general object is solved by the subject matter of the independent claims. Further advantageous embodiments result from the dependent claims and the overall disclosure.

A first aspect of the invention relates to a ceiling element for a cooling and/or heating ceiling, wherein the ceiling element comprises a ceiling panel. The ceiling panel has a ceiling panel upper side which, in the operative state, i.e. in the mounted state on a ceiling in a room, faces the ceiling and therefore faces away from the floor. The ceiling element also comprises a pipe system arranged on the ceiling panel upper side with pipes extending in the longitudinal direction of the ceiling panel. The pipes are designed to transport a heat-carrying fluid. Typically, the pipe system, and in particular the pipes, can be arranged directly on the ceiling panel upper side. The ceiling element also has an air outlet box arranged on the ceiling panel upper side with a supply air inlet and a plurality of air outlets open to the surroundings of the ceiling panel. The pipes of the pipe system extend through the air outlet box, i.e. they enter and/or emerge from the air outlet box. Furthermore, the air outlets of the air outlet box are arranged such that air exiting from the air outlets runs on the ceiling panel upper side. This means that the air that emerges from the air outlets and is therefore already emitted to the surroundings moves along the ceiling panel upper side before it is ejected towards the room in particular. Consequently, the air is not distributed vertically in the room through perforations, but exchanges heat in the air outlet box with the fluid in the pipes and leaves through the air outlets. The air then first moves along the ceiling panel upper side from where it subsequently leaves the ceiling element towards the floor of the room. Firstly, this prevents the occurrence of draughts and secondly, the air can continue to exchange heat with the pipes extending in the longitudinal direction or with the fluid transported in them as it emerges, which significantly increases the efficiency of the ceiling element.

The person skilled in the art understands that the pipes of the pipe system can also be connected to form a single pipe. Particularly preferably, the pipe system comprises or consists of a pipe meander, i.e. a plurality of pipes extending in the longitudinal direction, which are connected to one another via pipe bends.

Air outlets open to the surroundings are air outlets of the air outlet box through which the air is already ejected freely into the room and is therefore no longer routed in closed ducts or similar.

In some embodiments, the pipes extend through one, in particular two, of the air outlets through the air outlet box.

The air outlet box, in particular together with the ceiling panel upper side, defines an air chamber through which the pipes of the pipe system also extend. The air flows are typically not separated in the air chamber, i.e. the air outlet box does not have separate ducts or similar.

The air outlet box typically extends in the longitudinal direction over less than 50%, in particular over less than 40%, in particular over less than 30% of the ceiling panel, in particular over less than 20% of the ceiling panel, in particular over less than 10% of the ceiling panel.

In some embodiments, the air outlet box is arranged centrally in the longitudinal direction, i.e. in the middle of the ceiling panel. Thus, walls of the air outlet box have essentially the same distance along the longitudinal direction from the respective longitudinal ends of the ceiling element. Alternatively, it is possible for the air outlet box to be arranged at the end face, i.e. at a longitudinal end of the ceiling panel. In such embodiments, the air outlet box only has air outlets which are arranged opposite this longitudinal end of the ceiling panel.

Directional indications, as used here, are to be understood as follows: The longitudinal direction of the ceiling element extends along the longest side of the ceiling element. Typically, the pipes of the pipe system are arranged parallel to each other and all extend in the longitudinal direction. The ceiling element, and in particular the ceiling panel, can preferably be rectangular in shape or have a rectangular cross section. The longitudinal direction extends along the two longer sides of the rectangle. The transverse direction is arranged perpendicular to the longitudinal direction. In the operational, i.e. mounted, state, this extends essentially parallel to the ceiling or floor of the room, just like the longitudinal direction. The vertical direction is perpendicular to the longitudinal direction and the transverse direction and, when installed, extends from the ceiling towards the floor of the room. Typically, the ceiling element extends in the longitudinal direction and optionally in the transverse direction by a greater amount than in the vertical direction.

In some embodiments, the ceiling element also has a frame. Such a frame can surround the periphery of the ceiling panel. The frame can thus represent the peripheral outer boundary of the ceiling element. In certain embodiments, the frame may consist of a folded edge of the ceiling panel. In such embodiments, the frame surrounds the ceiling panel upper side peripherally.

In some embodiments, the air outlet box has no other openings or fluid connections to the environment in addition to the described air outlets and the supply air inlet.

In some embodiments, the air outlet box has a cuboid shape, a pyramid shape, a half-cylinder shape or the shape of a gable roof or a hipped roof.

In some embodiments, the air outlet box may be made of a sheet metal, i.e. a metallic sheet. In certain embodiments, the sheet metal may have a thickness of from 0.2 mm to 2 mm, in particular from 0.5 mm to 1 mm.

In some embodiments, the air outlet box may have a height, i.e. an extension in the vertical direction, of from 100 mm to 200 mm, in particular from 120 mm to 160 mm. In some embodiments, the air outlet box may have a width, i.e. an extension in the transverse direction, of from 400 mm to 1000 mm, in particular from 400 mm to 800 mm, in particular from 500 mm to 600 mm.

In some embodiments, the air outlets of the air outlet box are arranged such that air exiting from the air outlets runs along, and in particular parallel to, the pipes extending in the longitudinal direction of the ceiling panel. The air exiting from the air outlet box is therefore first conducted along the pipes of the pipe system such that the air is in direct contact with the pipes of the pipe system. This allows the air to exchange heat with the fluid in the pipes not only in the air outlet box, but also after it has been ejected from the air outlet box. This significantly increases the performance of the ceiling element. Furthermore, no additional air ducts or similar are required, which simplifies the construction of the ceiling element.

In some embodiments, the air outlets of the air outlet box are arranged such that the majority of the air exiting from the air outlets is ejected longitudinally from the ceiling element. The majority refers to more than 50% of the air. Preferably, even more than 60%, more than 70%, more than 80% or more than 90% of the air exiting from the air outlets is ejected from the ceiling element on the longitudinal side. The fact that such a high proportion of the air is ejected longitudinally and that the pipes of the pipe system also run longitudinally means that more heat can be exchanged with the heat-carrying fluid in the pipes, thereby increasing the efficiency of the ceiling element.

In some embodiments, the air outlets of the air outlet box are each arranged around a pipe of the pipe system. Thus, the air outlet box can therefore have a plurality of openings in the longitudinal direction of the ceiling panel, through which, on the one hand, the pipes of the pipe system run and, on the other hand, air can escape from the interior of the air outlet box into the environment. For example, the air outlets of the air outlet box can be arranged between an end wall of the air outlet box and the pipes, as well as the ceiling panel upper side. The air outlets can, for example, be curved, in particular semi-circular, or angular, in particular rectangular. Semi-circular air outlets can each have a radius of 10 mm to 50 mm, in particular 20 mm to 40 mm.

In some embodiments, the open area defined by the supply air inlet is larger than the open area defined by each of the air outlets.

In some embodiments, insulation, in particular sound and/or thermal insulation, is arranged on the ceiling panel upper side between the pipes of the pipe system. The insulations are preferably arranged between the pipes of the pipe system. Preferably, the insulation is only arranged on the part of the ceiling panel upper side being uncovered by the air outlet box. In particular, fiber materials such as fleece or foams can be used as insulation.

In some embodiments, the pipes of the pipe system are each fastened to the ceiling panel upper side by means of a heat conducting plate. The heat conducting plate can be made of metal, such as copper or aluminum. The heat conducting plate surrounds one pipe of the pipe system in each case, and also lies flat against the ceiling panel upper side on both sides beyond the pipe, or is fastened to it. The heat conducting plate can be fastened with a material bond, e.g. by welding, or with a force-fit, e.g. by means of screw or rivet connections. The skilled person understands that in such embodiments, the air exiting from the air outlet box is not in direct contact with the pipes, but with the respective heat conducting plate and exchanges heat with the fluid transported in the pipes via the heat conducting plates. Typically, the heat conducting plates are each 52-shaped (omega-shaped) in cross section. Such heat conducting plates increase efficiency as they permit better heat energy exchange.

In some embodiments, each heat conducting plate of each pipe extends through the air outlet box.

In some embodiments, the air outlet box defines an air chamber which has a volume of 1 L to 50 L, in particular 5 L to 30 L, in particular 10 L to 20 L.

In some embodiments, the air outlet box extends in the transverse direction completely, or at least over more than 90% of the extent of the ceiling panel upper side in the transverse direction, over the ceiling panel upper side. Thus, the air outlet box extends in the transverse direction from one transverse end of the ceiling panel to the opposite other transverse end of the ceiling panel. This increases the area within which heat can be exchanged within the air outlet box.

In some embodiments, the air outlet box, and in particular the air outlets, are each spaced apart from at least one or both longitudinal ends of the ceiling element by at least 40 cm, in particular at least 60 cm. This ensures that the air exiting from the air outlet box is conducted over a sufficiently long distance in the longitudinal direction, whereby a plurality of heat can be exchanged with the fluid in the pipes.

In some embodiments, the ratio of the area of the ceiling panel upper side covered by the air outlet box to the uncovered area of the ceiling panel upper side is between 1:5 and 1:80, in particular between 1:10 and 1:20.

In some embodiments, the ceiling element additionally comprises a supply air pipe. This is connected to the supply air inlet of the air outlet box. Supply air can therefore be introduced directly into the air outlet box via the supply air pipe and exchange heat energy with the pipes of the pipe system extending through the air outlet box.

In some embodiments, the air outlets of the air outlet box are each arranged in the longitudinal direction of the ceiling panel. Therefore, the air outlets are arranged such that the air exiting from the air outlet box flows parallel to the ceiling panel upper side, or parallel to the pipes, or parallel to the room ceiling when installed.

In some embodiments, the ceiling panel, and in particular a ceiling panel lower side arranged opposite the ceiling panel upper side, is closed. This means that the ceiling panel and the ceiling panel lower side facing the room or the floor in the installed state are free of pores or air outlets or openings.

In some embodiments, the air outlets of the air outlet box are arranged on both sides in the longitudinal direction of the ceiling panel such that some air outlets are arranged on opposite sides of the air outlet box. The air outlet box can have two opposite end walls arranged perpendicular to the longitudinal direction of the ceiling panel and thus in particular perpendicular to the pipes of the pipe system. Both of these end walls define or delimit air outlets. Thus, some air outlets are arranged on opposite sides of the air outlet box. Preferably, the air outlets on both sides, or in both end walls, are arranged symmetrically to the air outlets on the corresponding other side, or the other end wall. In some embodiments, an air outlet on the first end wall is aligned with an air outlet on the second end wall opposite the first end wall.

In some embodiments, the air outlets are delimited or defined by a wall, in particular by an end wall, of the air outlet box and by the ceiling panel upper side. This can ensure that air exiting from the air outlets is runs on the ceiling panel upper side.

In some embodiments, the air outlet box has a cover holder. This cover holder can, for example, be a recess in an end wall of the air outlet box. A cover is inserted into the cover holder. In particular, the cover can be inserted in a detachable manner, i.e. the cover can be inserted into and removed from the cover holder several times. The contact area between the cover and the cover holder, in particular the end wall, can preferably be fluid-tight. The cover can have no air outlets, i.e. it can be designed as a continuous plate or without air outlets. Such embodiments are advantageous if the air outlet box is arranged at one end face of the ceiling panel. Such an air-outlet-free cover prevents the air from being emitted directly from the end face of the ceiling panel and being conducted into the room via the ceiling panel through air outlets on the end wall of the air outlet box opposite this end face. Alternatively, the cover may have one or a plurality of air outlets as disclosed in some embodiments described herein. An air outlet box with such a cover holder has the advantage that it can be used flexibly. Thus, it is not necessary to use different air outlet boxes for air outlet boxes arranged on the face of the ceiling panel than for air outlet boxes arranged centrally on the ceiling panel.

A second aspect of the invention relates to the use of a ceiling element according to one of the embodiments described herein for heating or cooling a room.

In some embodiments, the use comprises guiding air via the supply air inlet into the air outlet box, in particular into the air chamber, exchanging heat energy with a heat-carrying fluid located in the pipes and subsequently exiting the air outlet box via the air outlets and running the air along the ceiling panel upper side.

In some embodiments, the air exiting from the air outlets runs along the pipes extending in the longitudinal direction of the ceiling panel.

In some embodiments, the majority of the air exiting from the air outlets is ejected longitudinally from the ceiling element. Preferably, even more than 60%, more than 70%, more than 80% or more than 90% of the air exiting from the air outlets is ejected from the longitudinal side of the ceiling element.

### BRIEF DESCRIPTION OF SEVERAL VIEWS OF THE DRAWINGS

Aspects of the invention are explained in more detail with reference to the specific embodiments shown in the following figures and the associated description. The embodiments shown in the figures are not to be understood as limiting the invention described in the claims.

FIG. 1 shows a perspective view of a ceiling element according to one embodiment of the invention;

FIG. 2 shows a perspective view of the back of the ceiling element shown in FIG. 1;

FIG. 3 shows a section along the transverse direction through the ceiling element of FIGS. 1 and 2;

FIG. 4 shows a perspective view of an air outlet box as present in a further embodiment of the invention;

FIG. 5 shows the increase in performance of a ceiling element according to one embodiment of the invention compared to a ceiling element without an air outlet box according to the invention.

### DETAILED DESCRIPTION OF THE INVENTION

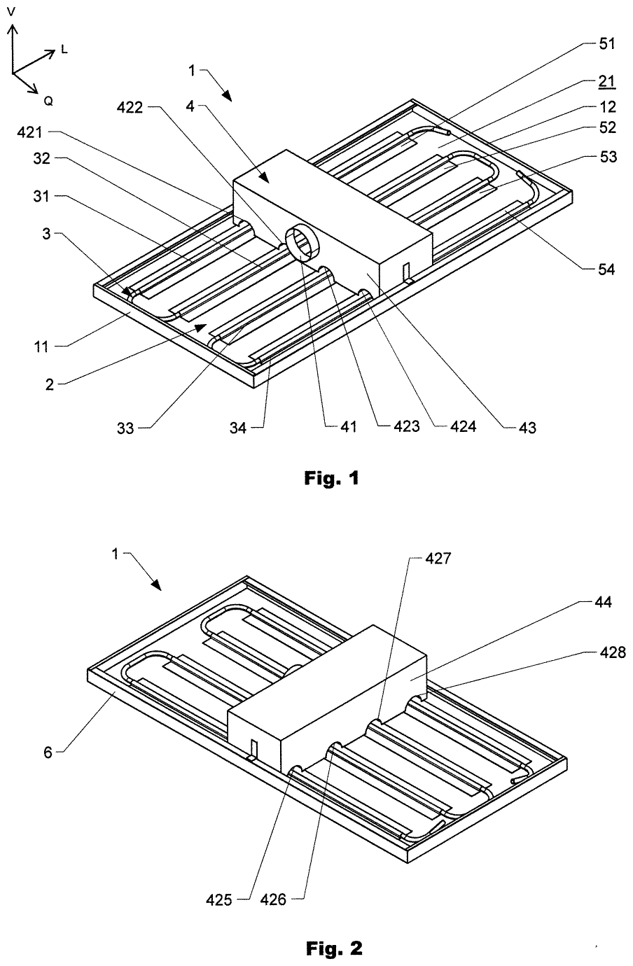

FIG. 1 shows a ceiling element 1 according to the invention with a ceiling panel 2. The ceiling panel 2 has a ceiling panel upper side 21 on which a pipe system 3 is arranged. The pipe system 3 comprises four pipes 31, 32, 33 and 34 extending in the longitudinal direction L of the ceiling panel, which are connected to one another via three pipe bends and thus form a single fluid line.

In addition, the ceiling element 1 comprises an air outlet box 4 arranged on the ceiling panel upper side 31, which has a supply air inlet 41 and a plurality of air outlets 421, 422, 423 and 424 open to the surroundings. The pipes 31, 32, 33 and 34 each extend through two of the air outlets (one on each side of the air outlet box) through the air outlet box 4. Air that emerges from the air outlet box through the air outlet openings runs on the ceiling panel upper side. In contrast to ceiling elements known in the prior art, the air therefore does not run in the vertical direction below the ceiling panel upper side, but on the ceiling panel upper side, i.e. between the ceiling panel upper side 21 and the room ceiling in the installed state. Furthermore, the exiting air runs along the pipes 31, 32, 33 and 34, which permits further heat energy to be exchanged efficiently with the heat-carrying fluid in the pipes, even outside the air outlet box 4. In addition, the majority of the air exiting from the air outlets flows longitudinally away from the ceiling element, i.e. via its longitudinal ends 11 and 12. The air outlet box 4 extends in the transverse direction Q of the ceiling panel over more than 90% of the extent of the ceiling panel surface in the transverse direction.

The pipes 31, 32, 33 and 34 are also each fastened to the ceiling panel surface 21 with a separate heat conducting plate 51, 52, 53 and 54. These heat conducting plates also extend through the air outlet box 4, and thus through the air chamber defined by the air outlet box, via the corresponding air outlets.

The air outlets 421, 422, 423 and 424 are each essentially defined or delimited exclusively by the end wall 44 of the air outlet box and the ceiling panel upper side 21.

In FIG. 2, the ceiling element of FIG. 1 is shown from a different, i.e. rotated, perspective. It can be seen that four air outlets 425, 426, 427 and 428 are also arranged on the side opposite the end wall 43, from which the pipes and correspondingly the heat conducting plates emerge from the air outlet box. Preferably, in this embodiment or in any other embodiment described herein, two air outlets may be aligned with each other along the longitudinal direction. In the embodiment shown, the pairs of air outlets 421/428, 422/427, 423/426 and 424/425 align with each other. The ceiling panel surface is peripherally surrounded by the frame 6, which is formed by a chamfer of the ceiling panel in the vertical direction.

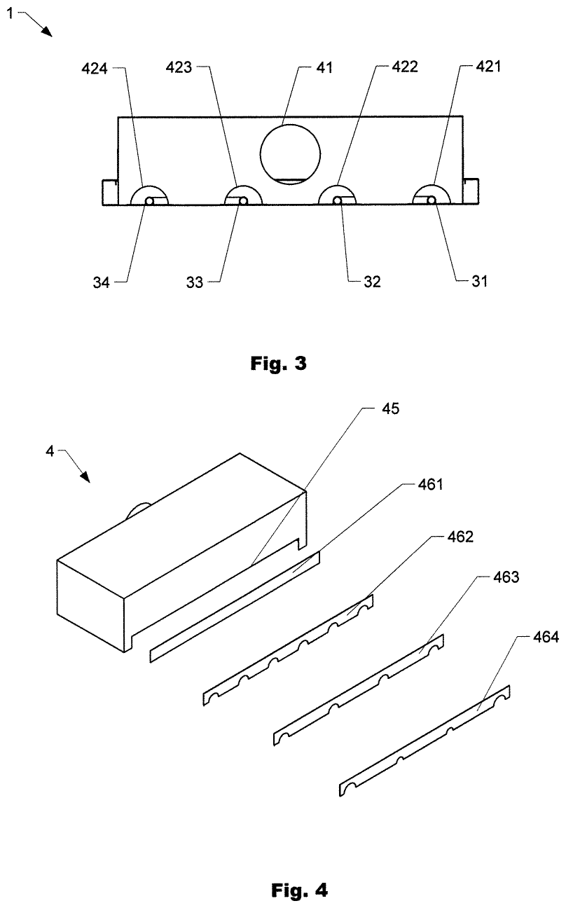

FIG. 3 shows a section along the transverse direction through the air outlet box of the ceiling element 1 of FIG. 1. Here it can be seen that the air outlets 421, 422, 423 and 424 are each delimited or defined by the end wall 43 (see FIG. 1) of the air outlet box and the ceiling panel upper side. The pipes 31, 32, 33 and 34 run through these outlets. Thus, the outlets surround the pipes correspondingly peripherally, with the air outlet forming between the pipes, or the heat conducting plates surrounding them, and the end wall.

FIG. 4 shows an air outlet box 4. This has the cover holder 45 into which one of the covers 461, 462, 463 or 464 can be inserted or is inserted. While the covers 462 to 464 have a plurality of air outlets, the cover 461 is free of air outlets, i.e. continuous. In the latter embodiment, no air is ejected via the corresponding visible end wall of the air outlet box 4. This air can only escape from the air outlet box via air outlets in the opposite end wall. In the cover 464, the air outlets are formed in two different opening surfaces. In general, it is possible in this and also in other embodiments described here for the air outlets of the air outlet box to have opening areas of different sizes.

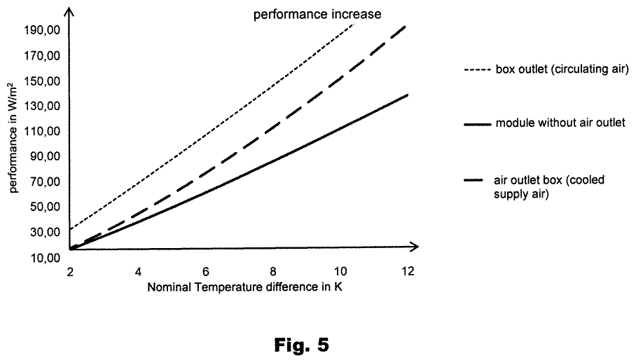

FIG. 5 shows the increase in room cooling performance as a function of the temperature difference, which can be achieved by means of a ceiling element according to the invention with an air outlet box (dashed lines) compared to such a ceiling element without an air outlet box (solid line). The short dashed line (---) shows the increase in performance with a supply air flow at room temperature (26° C.) and the long dashed line (---) shows the increase in performance with a supply air flow that is cooled by 4 K compared to the room temperature (26° C.), i.e. has a temperature of 22° C.

1. A ceiling element (1) for a cooling and/or heating ceiling, comprising:
a. a ceiling panel (2) with a ceiling panel upper side (21);
b. a pipe system (3) arranged on the ceiling panel upper side (21) with pipes (31, 32, 33, 34) extending in the longitudinal direction (L) of the ceiling panel for transporting a heat-carrying fluid;
c. an air outlet box (4) arranged on the ceiling panel upper side (31) with a supply air inlet (41) and a plurality of air outlets (421, 422, 423, 424, 425, 426, 427, 428) open to the surroundings, wherein the pipes (31, 32, 33, 34) of the pipe system (31) extend through the air outlet box (4) and wherein the air outlets (421, 422, 423, 424, 425, 426, 427, 428) are arranged such that air exiting from the air outlets (421, 422, 423, 424, 425, 426, 427, 428) runs on the ceiling panel upper side (21).

2. The ceiling element (1) according to claim 1, wherein the air outlets (421, 422, 423, 424, 425, 426, 427, 428) are arranged such that air exiting from the air outlets (421, 422, 423, 424) runs along the pipes (31, 32, 33, 34) extending in the longitudinal direction (L) of the ceiling panel (2).

3. The ceiling element (1) according to claim 1, wherein the air outlets (421, 422, 423, 424, 425, 426, 427, 428) are arranged such that the majority of the air exiting the air outlets is ejected from the ceiling element (1) longitudinally.

4. The ceiling element (1) according to claim 1, wherein the air outlets (421, 422, 423, 424, 425, 426, 427, 428) of the air outlet box (4) are each arranged around a pipe (31, 32, 33) of the pipe system (3).

5. The ceiling element (1) according to claim 1, wherein insulations, in particular sound and/or heat insulations, are arranged on the ceiling panel upper side (21), between the pipes (31, 32, 33, 34) of the pipe system (3) only on the part of the ceiling panel upper side (21) being uncovered by the air outlet box (4).

6. The ceiling element (1) according to claim 1, wherein the pipes (31, 32, 33, 34) of the pipe system (3) are each fastened to the ceiling panel upper side (21) by a heat conducting plate (51, 52, 53, 54).

7. The ceiling element (1) according to claim 1, wherein the air outlet box (4) defines an air chamber which has a volume of at least one of from 1 L to 50 L, from 5 L to 30 L, and from 10 L to 20 L.

8. The ceiling element (1) according to claim 1, wherein the air outlet box (4) extends in the transverse direction completely or at least over more than 90% of the extension of the ceiling panel upper side in the transverse direction, over the ceiling panel upper side (21).

9. The ceiling element (1) according to claim 1, wherein the air outlet box (4), and the air outlets (421, 422, 423, 424, 425, 426, 427, 428), is spaced apart from the longitudinal ends (11, 12) of the ceiling element (2) by at least 40 cm.

10. The ceiling element (1) according to claim 1, additionally comprising a supply air pipe connected to the supply air inlet (41).

11. The ceiling element (1) according to claim 1, wherein the air outlets (421, 422, 423, 424, 425, 426, 427, 428) of the air outlet box are each arranged in the longitudinal direction (L) of the ceiling panel (2).

12. The ceiling element (1) according to claim 1, wherein the ceiling panel (2), wherein a ceiling panel lower side arranged opposite the ceiling panel upper side (21), is closed, free of pores and/or free of air outlets.

13. The ceiling element (1) according to claim 1, wherein the air outlets (421, 422, 423, 424, 425, 426, 427, 428) of the air outlet box (4) are arranged on both sides in the longitudinal direction (L) of the ceiling panel (2) in such a way that some air outlets (421, 422, 423, 424, 425, 426, 427, 428) are arranged on opposite sides of the air outlet box (4).

14. The ceiling element (1) according to claim 1, wherein the air outlets (421, 422, 423, 424, 425, 426, 427, 428) are delimited by an end wall (43, 44) of the air outlet box (4) and by the ceiling panel upper side (21).

15. The ceiling element (1) according to claim 1, wherein the air outlet box (4) comprises a cover holder (45) and a cover (461, 462, 463, 464) inserted into the cover holder (45), wherein the cover (461, 462, 463, 464) comprises either no air outlets or one or more air outlets.

16. Use of a ceiling element (1) according to claim 1 for heating or cooling a room, wherein air is fed into the air outlet box (4) via the supply air inlet (41) and exchanges heat energy with a heat-carrying fluid located in the pipes and subsequently runs from the air outlet box (4) via the air outlets (421, 422, 423, 424, 425, 426, 427, 428) and subsequently on the ceiling panel upper side (21).
